(19) United States
(12) Patent Application Publication
(10) Pub. No.: US 2006/0126942 A1
(43) Pub. Date: Jun. 15, 2006

(54) Method of and apparatus for retrieving movie image

(76) Inventors: Mei Kodama, Hiroshima (JP); Tomoji Ikeda, Hiroshima (JP)

Correspondence Address: WELLS ST. JOHN P.S., 601 W. FIRST AVENUE, SUITE 1300, SPOKANE, WA, 99201, US

(21) Appl. No.: 11/341,965

(22) Filed: Jan. 26, 2006

Related U.S. Application Data
(63) Continuation of application No. 09/975,783, filed on Oct. 10, 2001.

(30) Foreign Application Priority Data
Oct. 10, 2000 (JP) 2000-309364

(51) Int. Cl. G06K 9/46; H04N 5/44

(52) U.S. Cl. 382/190; 715/722

(57) ABSTRACT

The movie image retrieving apparatus includes an image input device 13 to which the movie images are inputted in a time-series manner, a feature value calculation device 14 which includes a feature value deriving section 16 for deriving the feature value and a quantization section 17 which quantizes the feature value with a predetermined quantization width to produce the feature value information, a comparative information selection device 15 for deriving the comparative feature value information from the data-base, and a matching device 18 for matching the feature value information and the comparative feature value information using a quantization error. The matching result is outputted from the output device 19. Load on the hardware is reduced and the time required for the search is shortened.

### RELATED APPLICATIONS

This application relates to and claims a priority from corresponding Japanese Patent Application No. 2000-309364 filed on Oct. 10, 2000.

### BACKGROUND OF THE INVENTION

1. Field of the Invention

The present invention relates to a method of and an apparatus for effectively retrieving or searching the movie image information for use in the multimedia information utilization field.

2. Description of the Related Art

Due to the fact that the computer is becoming high-speed and of large capacity in recent years, the data-base construction for the movie image information such as the movie and the video which have not been treated conventionally is becoming dramatically active. In accordance with this fact, techniques for effectively retrieving or searching a desired scene from a very large quantity of stored movie images have been put into practical.

Such retrieval techniques for effectively selecting out the desired scene are classified largely into two methods. First method is one wherein indexes or key-words are assigned in advance to the movie image information and, at the retrieval operation, the user applies the key-word or search condition to the computer so that the desired movie image is detected. Second method is one wherein the brightness of color of the movie image is utilized as a key to detect the desired movie image.

However, in the above method wherein the indexes or key-words are assigned in advance to the movie image information, there is a difficulty, for the user who has only ambiguous memory or insufficient information, in setting an appropriate search condition. Further, there is a problem in that search results themselves become incorrect depending on the memory or information that the user has or on the manner of the search key-words.

In the second method wherein spatial signals such as the brightness or color of the images are used as keys, since the movie image information has greater quantity of data as compared to the text information or static image information, if the signal representing the movie image is subjected to the matching operation as it is, there occurs a problem in rendering the load on the hardware large and in increasing the time required for the searching process due to the large amount of information.

With the above problems in the prior art taken into consideration, an object of the present invention is to provide a method of and an apparatus for retrieving the movie image in which the necessary search is realized without depending on the memory or information that the user has and the manner of expression of the key-words, and in which the speed of the searching process is made high by decreasing the amount of information to be processed.

According to the invention, to solve the above problems, there is provided a method of retrieving the movie image, comprising the steps of:
sequentially inputting, into a processor, the subject movie images from the movie image information comprising a number of successive images;
deriving feature values which vary in time from the signal of the inputted movie images;
producing feature value information by quantization of the time feature value of the derived signal with a predetermined width of quantization; and
matching, using a quantization error, the feature value information with the feature value information of the movie images stored in advance in the data-base.

In this way, the subject movie image is time-sequentially inputted into the processor and, in the processor, from the inputted movie image signals there is derived the feature values which vary in time. Then, the derived time feature value of the signals is quantized with the predetermined width of quantization to produce the feature value information, and the feature value information thus obtained is matched using the quantization error with the quantized time feature value of the movie image information stored in advance in the data-base. The feature value of the movie image information for a specific scene is consecutive in time and there is a tendency that the value of the signal greatly varies when there occurs an abrupt change in the movie image or there occurs switching of the scenes. This can be detected by deriving the feature values which vary in time. Further, by quantizing the derived time feature value of the signals with the specific width of quantization, the region of wave is divided into finite number of small regions each region representing the specified value for the region. As a result, the amount of data to be processed becomes small and thus the problem wherein the load on the hardware becomes large is effectively solved, and the shortening of the search processing time can be achieved.

In another aspect of the invention, there is provided an apparatus for retrieving the movie image comprising:
an image input means for sequentially inputting, into a processor, the subject movie images from the movie image information comprising a number of successive images;
a feature value calculation means which comprises a feature value deriving section for deriving feature values which vary in time from the signal of the movie images inputted through the image input means, and a quantization process section for quantizing, with a predetermined width of quantization, the feature value derived from said feature value deriving section;
a comparative information selection means for deriving, from a data-base that stores information in advance, comparative information corresponding to the movie image inputted through the image input means;
a matching process means for performing movie image matching using a quantization error between the feature value information obtained at the quantization process section in the feature value calculation means and the feature value information derived at the comparative information selection means; and
a search result process means for outputting the result obtained at the matching process means.

With this apparatus, the problem in which the load on the hardware becomes large has been solved and shortening of the processing time has been achieved.

### BRIEF DESCRIPTION OF THE DRAWINGS

The above and other objects, features and advantages of the present invention will be apparent from the following description of preferred embodiments of the invention explained with reference to the accompanying drawings, in which:

FIG. 1 is a block diagram showing the basic principle of the present invention;

FIG. 2 is a block diagram showing the hardware construction embodying the present invention;

FIG. 3 is a block diagram showing the movie image searching processes executed in the CPU in FIG. 2;

FIG. 4 is a diagram showing an example wherein the feature value of the movie image at the input side is derived and is quantized;

FIG. 5 is a flow-chart showing the searching procedures according to the invention;

FIG. 6 is a block diagram showing an embodiment of the movie image searching apparatus according to the invention;

FIG. 7 is a block diagram showing an example wherein the feature value information is calculated from the luminance information;

FIG. 8 is a diagram showing an example of quantization of the luminance value as the time feature value;

FIG. 9 is a flow-chart showing the procedures of the embodiment of the invention;

FIG. 10 is a block diagram showing an embodiment wherein the correlation calculated from the luminance value distribution is used as the feature value information;

FIG. 11 is a diagram showing an example of the quantization of the correlation value calculated from the luminance value distribution as the time feature value; and

FIG. 12 is a flow-chart showing the procedures of the embodiment of the invention.

### PREFERRED EMBODIMENTS OF THE INVENTION

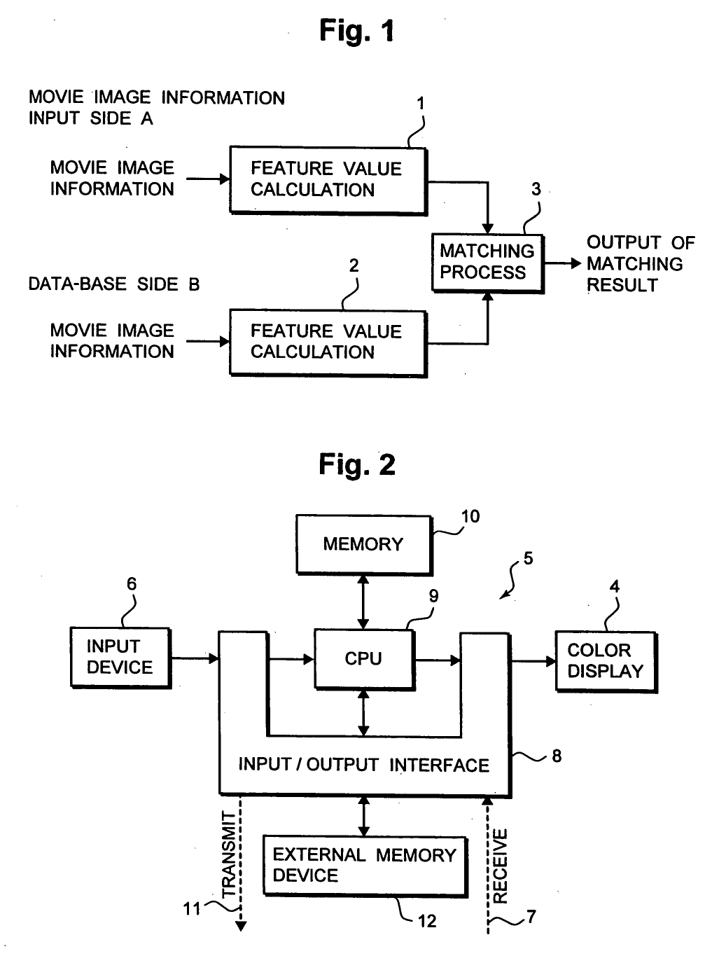

Now, embodiments according to the invention are explained with reference to the drawings. FIG. 1 is a block diagram showing the principle of the present invention.

Since the information (time series information) such as the movie image information or the audio information that has a time axis, that is, that changes in time sequence can be treated as waveform data, it is possible to determine whether an input data exists in the stored information by making the matching of the above waveform data with respect to the large amount of the stored information.

This invention enables a high-speed matching determination by obtaining the feature values from the time changing signal such as the movie image information and then the obtained feature value information is quantized with the predetermined width of quantization. With reference to FIG. 1, the movie image information at the movie image information input side A to which a search request is applied is inputted to one feature value calculation means 1. In the calculation means 1, the feature value is obtained from the time changing image information and then is quantized with the specific width of quantization. In the same manner, the movie mage information at the data-base side B is inputted to the other feature value calculation means 2. In the calculation means 2, the feature value is obtained and is quantized with the specific width of quantization. The feature value information thus obtained is inputted into the matching process means 3 in which the matching is performed and from which the matching results are outputted.

Here, assuming that the feature value at the move image information input side A is Fi and that at the data-base side B is F_{d}, the matching process between both the values is represented by the following Formula (1).
(Fᵢ−F_{d})²≦Th (1)
As represented by Formula (1), by determining both the feature value information with the threshold value Th which is the quantization error, it is possible to detect such time changing information as the movie image information and the audio information. In this invention, since the time changing feature values are effectively quantized, the amount of data subjected to the matching process is decreased, thereby enabling the high-speed search process.

Now, the apparatus according to the present invention is explained in more detail. FIG. 2 is a block diagram showing a system structure embodying the invention. Numeral 4 denotes a color display such as a CRT which displays an output of the computer 5. Commands or requests to the computer 5 are inputted through an input device 6 such as a keyboard or a mouse. Numeral 7 denotes a receiving line through which the search request information from the user's terminal device (not shown) is transmitted.

In the computer 5 which has received the search request information through the input/output interface 8, the CPU 9 derives the feature value of the time changing image signal from the image information included in the search request information, and produces the feature value information by being quantized with the specific width of quantization, in accordance with the programs stored in the memory 10.

The computer 5 reads out the feature value information in the data-base stored in the external memory device 12, performs the matching using the quantization error with the feature value information produced from the input image, and outputs the results thereof. The search result is displayed on the display device 4 or, if necessary, returned to the user's terminal (not shown) through the input/output interface 8 and the transmitting line 11, that emitted the search request. Here, in the computer 5, in the case where the search of the image information within the user's terminal is to be effected without through the network, it is possible to conduct the search process of the movie image with the use of the input/output interface 8.

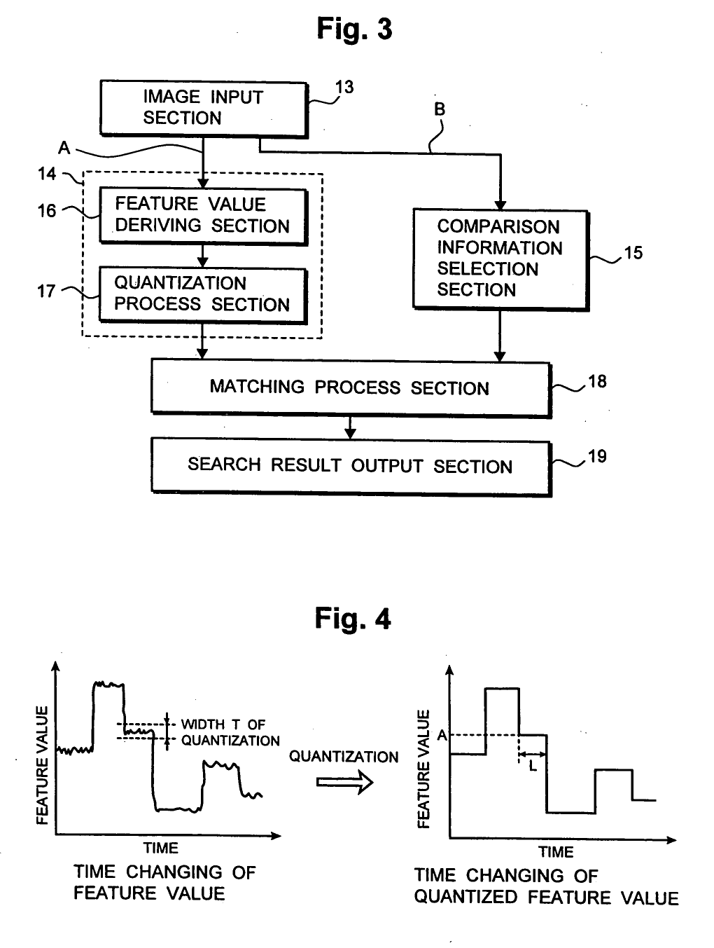

FIG. 3 is a block diagram showing the movie image searching processes performed in the CPU 9 in FIG. 2. The movie image searching method of the present invention is explained with reference to FIG. 3.

In the computer 5, the image to be processed in the CPU 9 is read-in into the image input section 13 through the input/output interface 8 in accordance with the program in the memory 10. Next, the signal of the read-in movie image information is divided into two routes, one being the route A directed to the feature value calculation section 14 where the time feature value is obtained, and the other being the route B directed to the comparison information selection section 15 where the feature value information stored in the data-base to be matched with the above feature value information is selected. Specifically, the feature value deriving section 16 in the feature value calculation section receives the image information from the image input section 13 and derives therefrom the signals of the brightness or the color that becomes the feature value of the input image.

The derived information obtained at the feature value deriving section 16 is then inputted into the quantization process section 17 where the feature value is quantized with the specific width of quantization and is divided into a finite number of small regions, the information in each of those regions being represented by the specified value. The feature value information usable to the matching process is thus produced and then inputted to the matching process section 18.

On the other hand, the comparison information selection section 15, in accordance with the image information inputted into the image input section 13, operates to select at the data-base side B the feature value information which becomes the comparison information and which corresponds to the inputted image information. The feature value information thus selected is inputted to the matching process section 18. The matching process section 18 receives the feature value information from the input side A and that from the data-base side B, and performs the matching operation on both the information. The result of this process is forwarded to the search result output section 19 which outputs the search result.

Next, the quantization process section 17 which is a principal element in this invention is explained in detail with reference to FIG. 4.

FIG. 4 is a graph which shows the changing levels in the direction of time, of the feature value of the image signal such as the brightness or the color of the movie image information. As shown in the drawings, the movie image information changes in its feature value in time for a given scene, and there is a tendency that the feature value largely changes in its level in the case where the image greatly changes or the scene is switched over from one to another. By utilizing the feature value of the image signal which varies in time, the width of the variation is quantized with the width T of quatization, whereby the representative value A of the feature value of the period L in direction of time is determined. Here, the value A may be gained at the starting point or the ending point of the time period L, or it may be a mean value of the feature values in the same period L. Alternatively, the value A may be obtained by linear or non-linear division, for example, the peak or the center of the distribution in the quantization period and, further, quantization accompanying equalizing or weighting may be adopted.

The feature of the present invention is that, since time changing signal such as the brightness or color signal of the movie image information is utilized, any image sizes in the color space which can be processed by the computer can be utilized.

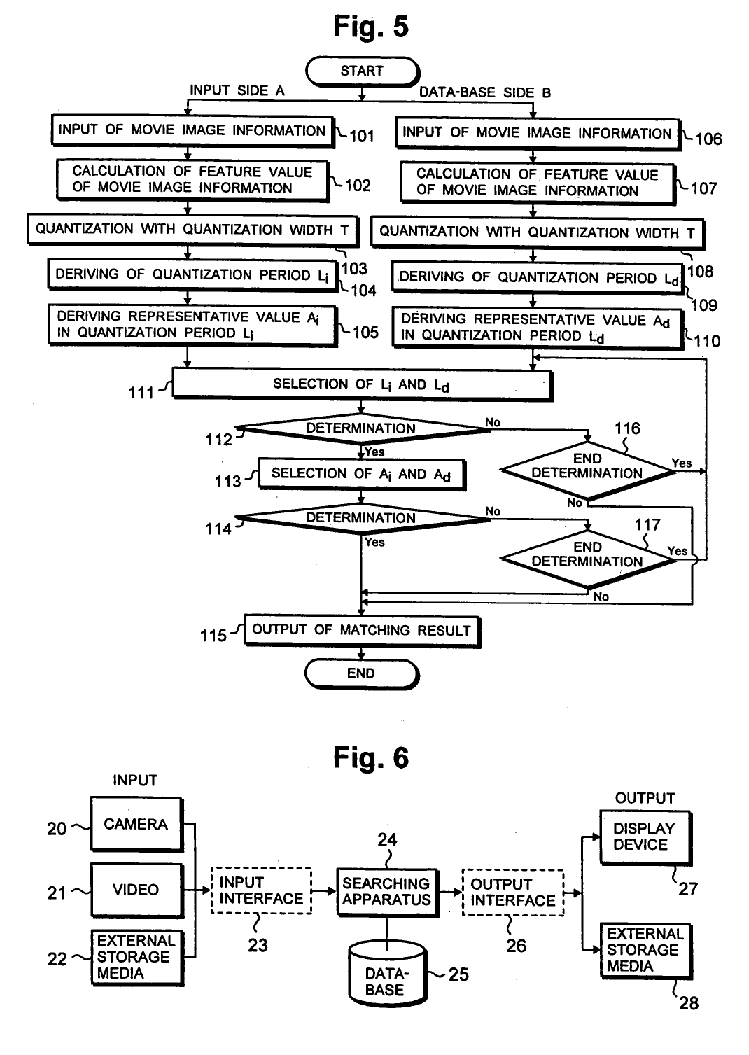

Next, the searching procedures of the present invention are explained with reference to the flow-chart of FIG. 5.

Step 101 through Step 105 are the processes for calculating the feature value information at the movie image information input side A. Step 106 through Step 110 are the processes for calculating the feature value information at the data-base side B. The movie image information is inputted in Step 101, the feature value of the movie image information, which is used for the matching process, is calculated in Step 102, and the feature value information calculated is quantized with the width T of quantization in Step 103. Further, the period Lᵢ subjected to the quantization is derived in Step 104, and the representative value Aᵢ at the quatization period Lᵢ is derived in Step 105. On the other hand, the same procedures as above are performed at the data-base side B. In Step 110, the representative value A_{d} at the quantization period L_{d} is derived. In this case, the feature value at the data-base side may have been calculated in advance with the process efficiency being taken into consideration.

Further, in Step 111, the quantization period Lᵢ in the input side A and that L_{d} in the data-base side B are selected and, in Step 112, a determination is made as to whether Lᵢ and L_{d} satisfy the Formula (1). If YES, the process goes to Step 113 in which a determination whether Aᵢ and A_{d} satisfy the Formula (1) is made. On the other hand, if NO, the process goes to Step 116 in which the end of matching is determined.

In Step 113, the representative values Aᵢ and A_{d} of both the quantization periods are selected, and a determination as to whether the values Aᵢ and A_{d} satisfy the Formula (1) in Step 114. If YES, the process goes to Step 115 in which the result of matching is outputted. If NO, the process goes to Step 117 in which the end of matching is determined.

Also, in Step 115, the result of matching is outputted and, in Step 116 a determination is made as to whether the next L_{d} exists or not. If YES, the process goes to Step 111 in which the next L_{d} is selected and continued to the matching process. If NO, the process goes to Step 115 in which the matching result is outputted. In Step 117, a determination as to whether the next L_{d} exists is made. If YES, the process goes to Step 111 in which the next L_{d} is selected and continued to the matching process. If NO, the process goes to Step 115 and the matching result is outputted.

### First Embodiment

Hereunder, some embodiments of the present invention are explained with reference to the accompanying drawings. FIG. 6 is a block diagram of the first embodiment which shows a movie image searching apparatus of the present invention. In this embodiment, the movie image information is inputted to the searching apparatus 24 from an input device, for example, a camera 20, a video player 21 and an external storage media 22. Here, the input device may be any type of device as far as it can process the movie image information. With the use of an input interface 23, the input of information from the network is also available. The time feature value of the inputted movie image information is subjected to the quantization according to the method of the invention, the effective matching is then performed, the necessary information is derived from the data-base 25 based on the search result, and the result of the searching operation is provided to the user through the output interface 26 and from the output device such as the display device 27 and the external storage media 28. Here again, through the output interface 26, presentation of the search result using the network is available.

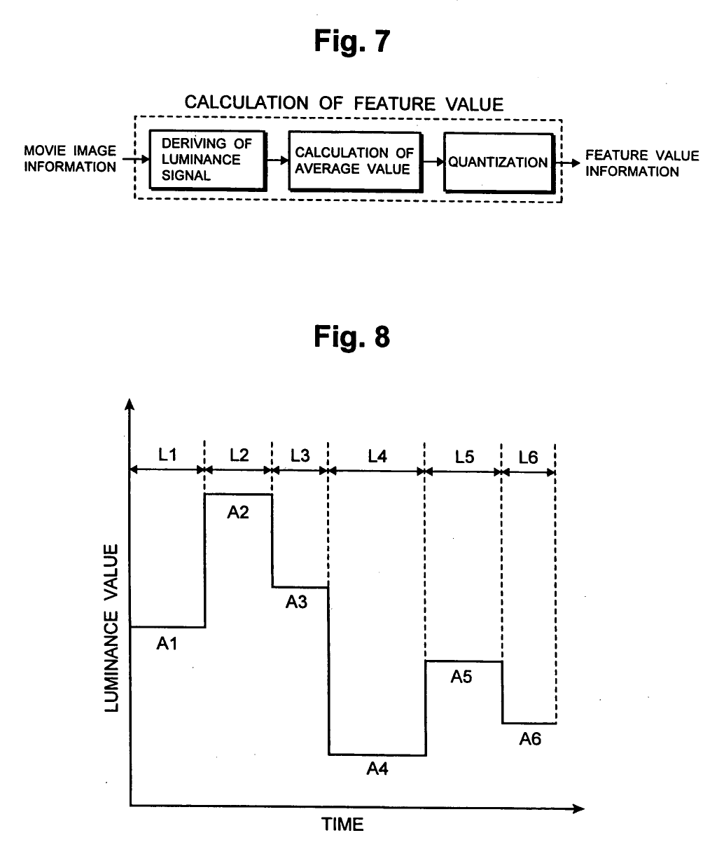

As the time feature value of the movie image information, it is possible to use any information derived from the numerical picture element data such as color, luminance and its average value or distribution value of the movie image information, or distribution information. In this embodiment, as shown in FIG. 7, the average value of the luminance signal is used as the time changing parameter of the movie image information. Referring to FIG. 7, the luminance value for each frame is obtained from the inputted movie image information and, then, the average value of the frame is calculated from the luminance value. By further quantizing the calculated average value, the quantization period and the representation value in that period are calculated. FIG. 8 is a graph showing the time changing aspect wherein the time feature value using the average value of the luminance value is subjected to quatization with the width T of quantization. FIG. 8 shows an example wherein the matching is performed using the quantization periods L₁ through L₆ and their representative values A₁ through A₆ of the respective periods of the movie image information.

If the luminance value of the image to be processed is assumed to have an 8-bit precision, the luminance value for each picture element can be represented by a_{xy} in the case where the size of the input image frame is x in vertical and y in horizontal. The average value of the luminance value in one (1) frame can be represented by the following Formula (2).

$$\overline{a} = \frac{1}{xy} {\sum }_{x = 0}^{255} {\sum }_{y = 0}^{255} {a}_{xy} \qquad ( 2 )$$

The feature value information is produced by obtaining the average values for the respective frames and then these average values are quantized with the quantization width T. This feature value information includes the quatization periods L₁ through L₆ and the representative values A₁ through A₆ shown in FIG. 8. In the same manner as above, the feature value information at the data-base side is produced and is compared with the respective values. Specifically, a determination between, for example, the quantization period Lᵢ at the input side and the quantization period L_{d} at the data-base side and, in the same manner, a determination between, for example, the representative value Aᵢ in that quantization period Lᵢ at the input side and the representative value A_{d} in that quantization period L_{d} at the data-base side are performed using the following Formulas (3) and (4).
(Lᵢ−L_{d})²≦Th (3)
(Aᵢ−A_{d})²≦Th (4)

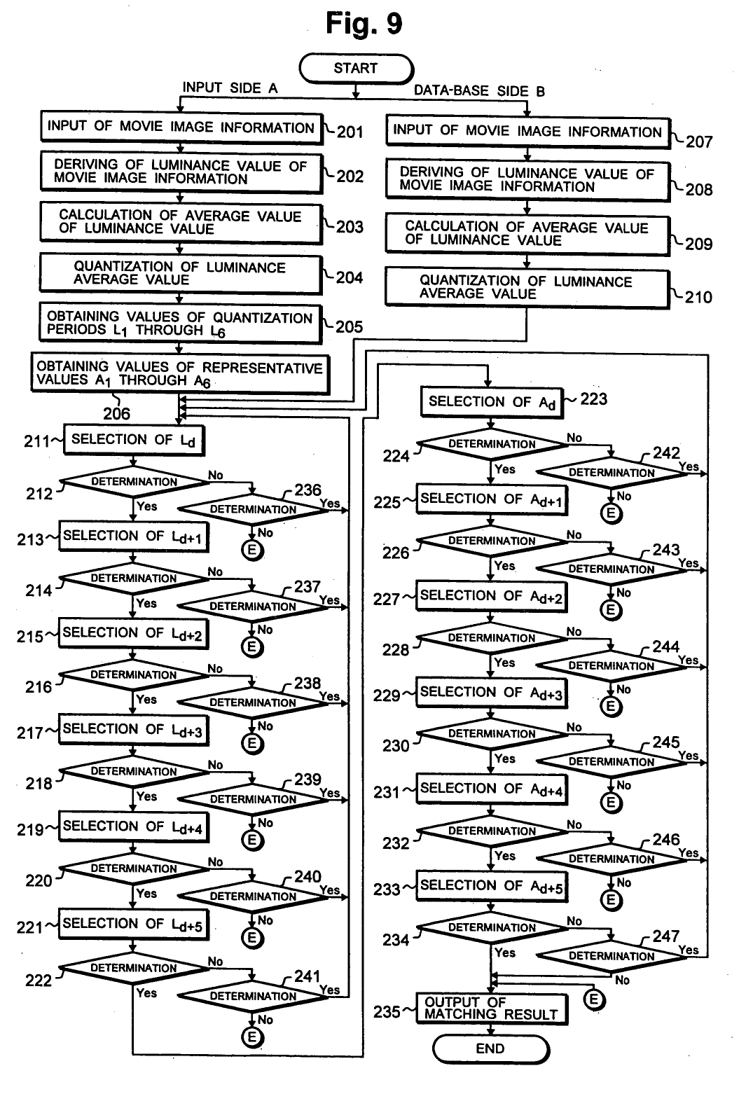

Next, the procedures of this embodiment are explained with reference to the flow-chart of FIG. 9.

Step 201 through Step 206 are the processes for calculating the feature value information at the movie image information input side A. Step 207 through Step 210 are the processes for calculating the feature value information at the data-base side B. The movie image information is inputted in Step 201, the luminance value of the movie image information is derived in Step 202, the average value is calculated from the derived luminance value in Step 203, and the quantization of the average value of the luminance value obtained in Step 203 is made in Step 204. In Step 205, the values of the quantization periods L₁ through L₆ are obtained and, in Step 206, the values of the representative values A₁ through A₆ corresponding to the quantiztion periods L₁ through L₆ are obtained. On the other hand, the similar procedures are performed at the data-base side B. Specifically, the movie image information at the data-base side is inputted in Step 207, the luminance value of the movie image information is derived in Step 208, the average value is calculated from the derived luminance value in Step 209, and the quantization of the average value of the luminance value obtained in Step 209 is made in Step 210. Up to the above steps at the data-base side, the feature values may have been calculated in advance with the process efficiency being taken into consideration.

Further, in Step 211, the quantization period L_{d} at the data-base side B is selected and, in Step 212 a determination is made as to whether L₁ and L_{d} satisfy the Formula (3). If YES, the process goes to Step 213 in which the period L_{d+1} is selected. On the other hand, if NO, the process goes to Step 236 in which the end of matching is determined.

In Step 213, the quantization period L_{d+1} at the data-base side B is selected and, in Step 214 a determination is made as to whether L₂ and L_{d+1} satisfy the Formula (3). If YES, the process goes to Step 215 in which the period L_{d+2} is selected. On the other hand, if NO, the process goes to Step 237 in which the end of matching is determined.

In Step 215, the quantization period L_{d+2} at the data-base side B is selected and, in Step 216 a determination is made as to whether L₃ and L_{d+2} satisfy the Formula (3). If YES, the process goes to Step 217 in which the period L_{d+3} is selected. On the other hand, if NO, the process goes to Step 238 in which the end of matching is determined.

In Step 217, the quantization period L_{d+3} at the data-base side B is selected and, in Step 218 a determination is made as to whether L₄ and L_{d+3} satisfy the Formula (3). If YES, the process goes to Step 219 in which the period L_{d+4} is selected. On the other hand, if NO, the process goes to Step 239 in which the end of matching is determined.

In Step 219, the quantization period L_{d+4} at the data-base side B is selected and, in Step 220 a determination is made as to whether L₅ and L_{d+4} satisfy the Formula (3). If YES, the process goes to Step 221 in which the period L_{d+5} is selected. On the other hand, if NO, the process goes to Step 240 in which the end of matching is determined.

In Step 221, the quantization period L_{d+5} at the data-base side B is selected and, in Step 222 a determination is made as to whether L₆ and L_{d+5} satisfy the Formula (3). If YES, the process goes to Step 223 in which the representative value A_{d} in the quantization period L_{d} is selected. On the other hand, if NO, the process goes to Step 241 in which the end of matching is determined.

In Step 221, the representative value A_{d} in the quantization period L_{d} at the data-base side B is selected and, in Step 224 a determination is made as to whether A₁ and A_{d} satisfy the Formula (4). If YES, the process goes to Step 225 in which the value A_{d+1} is selected. On the other hand, if NO, the process goes to Step 242 in which the end of matching is determined.

In Step 225, the representative value A_{d+1} at the data-base side B is selected and, in Step 226 a determination is made as to whether A₂ and A_{d+1} satisfy the Formula (4). If YES, the process goes to Step 227 in which the value A_{d+2} is selected. On the other hand, if NO, the process goes to Step 243 in which the end of matching is determined.

In Step 227, the representative value A_{d+2} at the data-base side B is selected and, in Step 228 a determination is made as to whether A₃ and A_{d+2} satisfy the Formula (4). If YES, the process goes to Step 229 in which the value A_{d+3} is selected. On the other hand, if NO, the process goes to Step 244 in which the end of matching is determined.

In Step 229, the representative value A_{d+3} at the data-base side B is selected and, in Step 230 a determination is made as to whether A₄ and A_{d+3} satisfy the Formula (4). If YES, the process goes to Step 231 in which the value A_{d+4} is selected. On the other hand, if NO, the process goes to Step 245 in which the end of matching is determined.

In Step 231, the representative value A_{d+4} at the data-base side B is selected and, in Step 230 a determination is made as to whether A₅ and A_{d+4} satisfy the Formula (4). If YES, the process goes to Step 233 in which the value A_{d+5} is selected. On the other hand, if NO, the process goes to Step 246 in which the end of matching is determined.

In Step 233, the representative value A_{d+5} at the data-base side B is selected and, in Step 234 a determination is made as to whether A₆ and A_{d+5} satisfy the Formula (4). If YES, the process goes to Step 235 in which the result of matching is outputted. On the other hand, if NO, the process goes to Step 247 in which the end of matching is determined.

In Step 235, the matching result as to whether the determination formula is satisfied is outputted.

In the Step 236 through Step 241, a determination is made as to whether the next quantization period L_{d}, L_{d+1}, L_{d+2}, L_{d+3}, L_{d+4} or L_{d+5} does exist or not. If YES, the process goes to Step 211 in which the matching is continued in the next quantization period L_{d} and, if No, the process goes to Step 235 in which the result of the matching is outputted.

In the Step 242 through Step 247, a determination is made as to whether the next representative value A_{d}, A_{d+1}, A_{d+2}, A_{d+3}, A_{d+4} or A_{d+5} does exist. If YES, the process goes to Step 211 in which the matching is continued in the next quantization period L_{d} and, if No, the process goes to Step 235 in which the result of the matching is outputted.

As explained above, it is possible to achieve the high-speed searching by conducting the matching using the length of the quantization period as a pattern. In the same way, it is also possible to achieve the desired searching by conducting the matching using the representative value. Here, as explained before, in the matching of the feature value information between the input side and the data-base side, all the steps are not necessarily performed. Matching result up to the intermediate step may well be used, if necessary. Further, the matching may well be such one as the combination of the quantization periods and the representative values, or such one as the partial combination of the quantization periods of the longest one. According to the present invention, by giving changing width or allowance to the quantization width T and the quantization period length L as well as the representative values at the respective quantization periods, it is possible to perform the search for the movie image information even in the case where the image size of the input image which is inputted as the search process condition is different from the image size of the image at the data-base side, or where the coding rate which is one factor to determine the amount of information is incorrect in the image compression technique which is used for reducing the amount of information of the image data.

### Second Embodiment

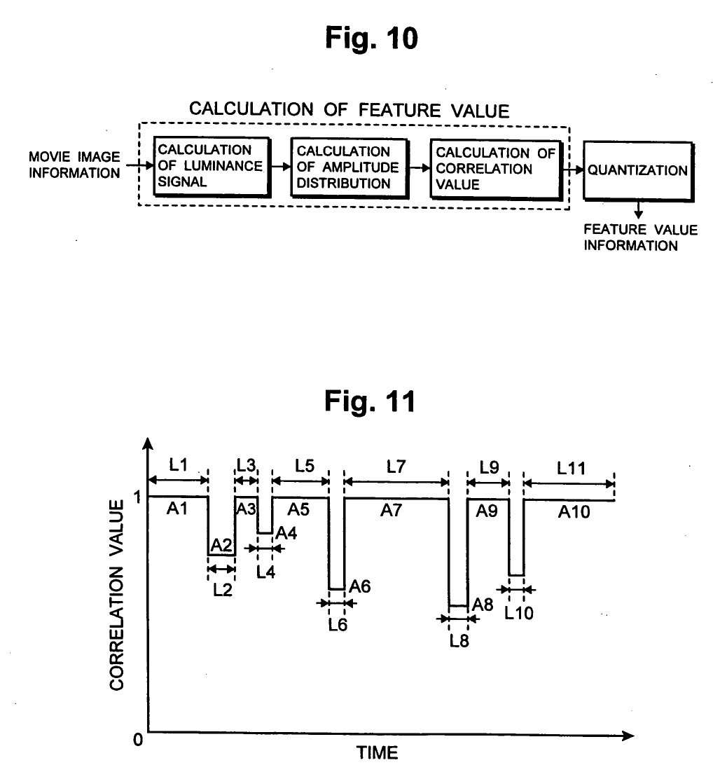

Next, another embodiment of the invention is explained. In this embodiment, as the time feature value of the movie image information, amplitude distribution of the luminance signal between before and after the frame of the movie image information, that is, the frequency distribution of the luminance signal is used and its correlation is utilized. FIG. 10 is a block diagram showing an embodiment wherein the correlation value calculated from the luminance value distribution is used as the feature value information. Referring to FIG. 10, first, the luminance signal is calculated from the inputted movie image information, the distribution of the amplitude thereof is obtained, then, the correlation value between before and after the frame from the above amplitude distribution information is calculated, and the quantization period and the representative values in the quantization period are calculated by the quantization of the correlation value. FIG. 11 is a graph showing the case wherein the correlation value calculated from the luminance value distribution is quantized as the time feature value. Since the feature value information of the inputted movie image information is the quantization of the correlation value, the time changing where the quantization is made with the quantization width T becomes the waveform as shown in FIG. 11. In FIG. 11, the matching is conducted with the longest quantization period L₇ among the quantization periods of the inputted movie image information, the quantization period L₆ which is before the quatization period L₇ by one, the quantization period L₈ which is after the quatization period L₇ by one, and the representative values A₆ and A₈ in both the quantization periods L₆ and L₈.

If the luminance value of the image to be processed here is assumed to have an 8-bit precision, first, the frequency distribution of the luminance values for the frames of the inputted image is obtained and, then, the correlation values between before and after the frame using the frequency distribution are obtained for the respective frames.

Specifically, assuming that the frequency distribution for the i-order frame is α and the frequency distribution for the (i+1)-order fame is β, the correlation C can be obtained from the following Formula (5).

$$c = \frac{{\sum }_{j = 0}^{255} ( {α}_{j} - \overline{α} ) ( {β}_{j} - \overline{β} )}{\sqrt{{\sum }_{j = 0}^{255} {( {α}_{j} - \overline{α} )}^{2} {\sum }_{j = 0}^{255} {( {β}_{j} - \overline{β} )}^{2}}} \qquad ( 5 )$$

Here,

$$\overline{α} = \frac{1}{256} {\sum }_{j = 0}^{255} {α}_{j} and \overline{β} = \frac{1}{256} {\sum }_{j = 0}^{255} {β}_{j}$$

In this way, the feature value information is produced by being quantized, with the quantization width T, the correlation value C calculated from between the before frame and the after frame. The feature value information includes the quantization periods L₁ through L₁₁ and the representative values A₁ through A₁₁. Similarly, the feature value information at the data-base side is produced. These values are subjected to the comparison operation. Namely, the quantization periods L₁ and L_{d} are determined using the following Formula (6), and the quatization period representative values Aᵢ and A_{d} are determined using the following Formula (7).
(Lᵢ−L_{d})²≦Th (6)
(Aᵢ−A_{d})²≦Th (7)

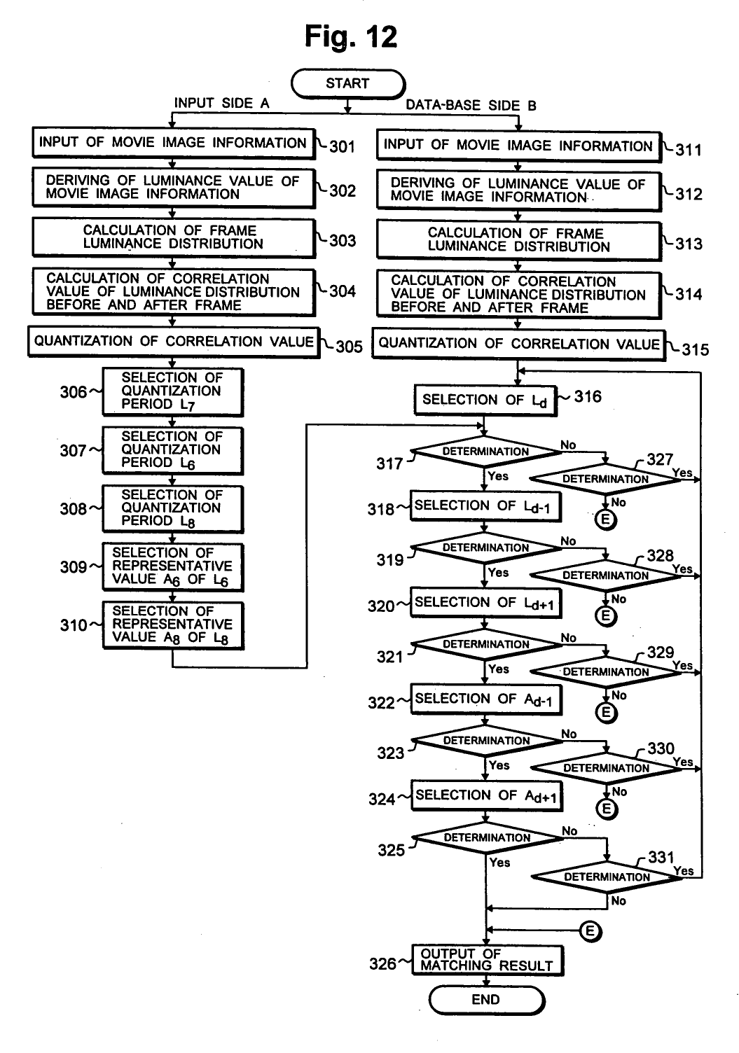

Next, the procedures of this embodiment are explained with reference to the flow-chart of FIG. 12.

Step 301 through Step 310 are the processes for calculating the feature value information at the movie image information input side A. Step 311 through Step 315 are the processes for calculating the feature value information at the data-base side B. The movie image information is inputted in Step 301, the luminance value of the movie image information is derived in Step 302, the distribution information is calculated in Step 303 from the derived luminance value in Step 302, and in Step 304 the correlation value of the luminance distribution before and after the frame is calculated. In Step 305, the quantization of the correlation values obtained in Step 304 is made.

In Step 306, the quantization period L₇ which is the longest one among the quantization periods is selected; in Step 307, the quantization period L₆ which is positioned before the quantization period L₇ is selected; and in Step 308, the quantization period L₈ which is positioned after the quantization period L₇ is selected. Next, in Step 309 the representative value A₆ in the quantization period L₆ is selected and, in Step 310, the representative value A₈ in the quantization period L₈ is selected.

On the other hand, in Step 311, the movie image information at the data-base side is inputted and, in Step 312, the luminance value of the inputted movie image information is calculated. Then, in Step 313, the distribution information is calculated from the luminance value obtained in Step 312. Further, in Step 314, the correlation value of the luminance distribution between before and after the frame is calculated. In Step 315, the quantization of the correlation values obtained in Step 314 is made. Up to the above steps at the data-base side, the feature value information may have been calculated in advance with the process efficiency being taken into consideration.

In Step 316, the quantization period L_{d} at the data-base side is selected and, in Step 317, a determination is made as to whether L₇ and L_{d} satisfy the Formula (6). If YES, the process goes to Step 318 in which the period L_{d-1} is selected. If NO, the process goes to Step 327 in which the end of matching is determined.

In Step 318, the quantization period L_{d-1} at the data-base side is selected and, in Step 319, a determination is made as to whether L₆ and L_{d-1} satisfy the Formula (6). If YES, the process goes to Step 320 in which the period L_{d+1} is selected. If NO, the process goes to Step 328 in which the end of matching is determined.

In Step 320, the quantization period L_{d+1} at the data-base side is selected and, in Step 321, a determination is made as to whether L₈ and L_{d+1} satisfy the Formula (6). If YES, the process goes to Step 322 in which the representative value A_{d-1} in the period L_{d-1} is selected. If NO, the process goes to Step 329 in which the end of matching is determined.

In Step 322, the representative value A_{d-1} in the quantization period L_{d-1} at the data-base side is selected and, in Step 323, a determination is made as to whether A₆ and A_{d-1} satisfy the Formula (7). If YES, the process goes to Step 324 in which the representative value A_{d+1} in the period L_{d+1} is selected. If NO, the process goes to Step 330 in which the end of matching is determined.

In Step 324, the representative value A_{d+1} in the quantization period L_{d+1} at the data-base side is selected and, in Step 325, a determination is made as to whether A₈ and A_{d+1} satisfy the Formula (7). If YES, the process goes to Step 326 in which the result of matching is outputted. If NO, the process goes to Step 331 in which the end of matching is determined.

In Step 326, the relevant data based on the result of matching is derived from the data-base and is outputted.

In Step 327 through Step 329, a determination is made as to whether the next quantization period L_{d}, L_{d-1} or L_{d+1} exists or not. If YES, the process goes to Step 316 in which the matching operation is continued for the next L_{d}. If NO, the process goes to Step 326 in which the matching result as to whether the Formula is satisfied is outputted.

In Step 330 through Step 331, a determination is made as to whether the next representative value A_{d-1} or A_{d+1} exists or not. If YES, the process goes to Step 316 in which the matching operation is continued for the next L_{d}. If NO, the process goes to Step 326 in which the matching result is outputted.

As explained above, according to the present embodiment, by giving changing width or allowance to the quantization width T and the quantization period length L as well as the representative values at the respective quantization periods, it is possible to perform the search for the movie image information even in the case where the image size of the input image which is inputted as the search process condition is different from the image size of the image at the data-base side, or in the case where the coding rate which is one factor to determine the amount of information is incorrect in the image compression technique which is used for reducing the amount of information of the image data. Further, here again, as explained before, in the matching of the feature value information between the input side and the data-base side, all the steps are not necessarily performed. Matching result up to the intermediate step may well be used, if necessary.

As explained hereinabove, according to the invention, because the amount of data used as input is reduced, the problem in that the load on the hardware becomes large is solved, and the shortening of time required for the search process is achieved.

While the invention has been described in its preferred embodiments, it is to be understood that the words which have been used are words of description rather than limitation and that changes within the purview of the appended claims may be made without departing from the scope of the invention as defined by the claims.

1. A method of retrieving a movie image, comprising the steps of:
sequentially inputting, into a processor, subject movie images from the movie image information comprising a number of successive images;
deriving feature values which vary in time from the signal of the inputted movie images;
producing first feature value information by quantization of the time feature values of the derived signal with a predetermined width of quantization;
deriving second feature value information which corresponds to the first feature value information and which is subjected to comparison operation, stored in advance in data-base; and
matching, using a quantization error, the first feature value information with the second feature value information in accordance with a predetermined determination formula.

2. A method of retrieving the movie image according to claim 1, in which said method further comprising a step of grouping the first feature value information using a predetermined standard so that third feature value information is produced, in which the second feature value information corresponding to the third feature value information is derived from the data-base storing in advance, and in which the matching for both the grouped feature value information is conducted using a grouped quantization error.

3. A method of retrieving the movie image according to claim 1, in which numerical picture element data such as luminance, brightness, saturation, color space, or frequency distribution thereof is used as the feature value information derived from the signal of the movie image.

4. A method of retrieving the movie image according to claim 1, in which in performing the matching using the quantization error, the step for producing the first feature value information is stopped if necessary and the matching result up to that time is outputted.

5. A method of retrieving the movie image according to claim 1, in which the matching using the quantization error is performed using the value of at least one quantization period length.

6. A method of retrieving the movie image according to claim 1, in which the matching using the quantization error is performed using the representative value of at least one quantization period.

7. A method of retrieving the movie image according to claim 1, in which the matching using the quantization error is performed using the value of at least one quantization period length and the representative value of at least one quantization period.

8. A method of retrieving the movie image according to claim 2, in which the third feature value information is produced by grouping using more than one quantization period lengths and the average or distribution representative value of representative values of more than one quantization periods.

9. A method of retrieving the movie image according to claim 1, in which, by using numerical data in synchronized audio information accompanying to the movie image information, retrieving of the movie image is conducted using an audio signal.

10. A method of retrieving the movie image according to claim 9, in which in performing the matching using the quantization error, the step for producing the first feature value information is stopped if necessary and the matching result up to that time is outputted.

11. An apparatus for retrieving a movie image comprising:
an image input means for sequentially inputting, into a processor, the subject movie images from the movie image information comprising a number of successive images;
a feature value calculation means which comprises a feature value deriving section for deriving feature values which vary in time from the signal of the movie images inputted through the image input means, and a quantization process section for quantizing, with a predetermined width of quantization, the feature value derived from said feature value deriving section so that feature value information is produced;
a comparative information selection means for deriving, from a data-base that stores information in advance, comparative feature value information corresponding to the movie image inputted through the image input means;
a matching process means for performing movie image matching in accordance with a determination formula using a quantization error between the feature value information obtained at the quantization process section in the feature value calculation means and the feature value information derived at the comparative information selection means; and
a search result process means for outputting the result obtained at the matching process means.

12. An apparatus for retrieving the movie image according to claim 11, in which said feature value calculation means further comprises a grouping section for grouping, based on a predetermined standard, the feature value information to produce new feature value information.

13. An apparatus for retrieving the movie image according to claim 11, in which numerical picture element data such as luminance, brightness, saturation, color space, or frequency distribution thereof is used as the feature value information derived from the signal of the movie image.

14. An apparatus for retrieving the movie image according to claim 11, in which the matching process means for conducting matching of the feature value information using the quantization error has a stop means for stopping the operation of the feature value calculation means if necessary, and an output means for outputting the matching result up to that time.

15. An apparatus for retrieving the movie image according to claim 11, in which the matching process means conducts matching using the value of at least one quantization period length.

16. An apparatus for retrieving the movie image according to claim 11, in which the matching process means conducts matching using the representative value in at least one quantization period.

17. An apparatus for retrieving the movie image according to claim 11, in which the matching process means conducts matching using the value of at least one quantization period length and the representative value of at least one quantization period.

18. An apparatus for retrieving the movie image according to claim 12, in which said grouping section produces the new feature value information by grouping more than one quantization period lengths and the averaged or distributed representative value of representative values of more than one quantization periods.

19. An apparatus for retrieving the movie image according to claim 11, in which numerical data in synchronized audio information accompanying to the movie image information is used to retrieve the movie image.

20. A method of retrieving the movie image according to claim 1, wherein:
the first feature value information comprises lengths of time for periods of quantization;
the second feature value information comprises lengths of time for periods of quantization; and
the matching comprises matching a pattern of the lengths of time for the first feature value information with a pattern of the lengths of time for the second feature value information.

21. An apparatus for retrieving the movie image according to claim 11, wherein:
the feature value information, obtained at the feature value calculation means, comprises lengths of time for periods of quantization;
the feature value information, derived at the comparative information selection means, comprises lengths of time for periods of quantization; and
the matching process means is configured to match a pattern of the lengths of time for the feature value information obtained at the feature value calculation means with a pattern of the lengths of time for the feature value information derived at the comparative information selection means.
